(19) United States
(12) Patent Application Publication
(10) Pub. No.: US 2024/0339870 A1
(43) Pub. Date: Oct. 10, 2024

(54) INDUCED ELECTROMOTIVE FORCE MEASUREMENT SYSTEM FOR INDUCTIVE POWER TRANSFER

(71) Applicant: IMPERIAL COLLEGE INNOVATIONS LIMITED, London (GB)

(72) Inventors: Nunzio PUCCI, London (GB); Juan ARTEAGA, London (GB); Paul MITCHESON, London (GB)

(21) Appl. No.: 18/579,752

(22) PCT Filed: Jul. 14, 2022
(86) PCT No.: PCT/EP2022/069813

§ 371 Date: Jan. 16, 2024

(30) Foreign Application Priority Data
Jul. 16, 2021 (GB) 2110295.9

(51) Int. Cl. H02J 50/60; H02J 50/12

(52) U.S. Cl. CPC H02J 50/60; H02J 50/12

(57) ABSTRACT

Disclosed herein are methods and systems of determining a magnetically induced voltage on a coil of a wireless power transmission device. The method comprises supplying DC input power to the wireless power transmission device. It further comprises monitoring a first variable associated with the wireless power transmission device, and monitoring a second variable associated with the wireless power transmission device, wherein at least one of the first and the second variable is derived from a switching waveform. It further comprises determining, based on at least one of the first variable, the second variable, and the relationship between the first variable and the second variable, the magnetically induced voltage on the coil of the wireless power transmission device.

This disclosure relates to a method of determining a magnetically induced voltage on a coil of a wireless power transmission device.

### BACKGROUND

Wireless Power transmission (WPT) devices allow the wireless transfer of power, for example between a WPT device and an electronic device. Magnetic induction WPT devices use magnetic fields to induce a current in nearby devices. These systems and devices do not require a physical connection between the WPT device and the electronic device. The need for wires or contacts is removed, and therefore WPT is not only convenient but in certain cases necessary.

Inductive power transfer (IPT) is an example of wireless power transfer (WPT). In an example inductive power transfer system, an alternating current passes through a transmitter coil. This causes the transmitter coil to produce a time-varying magnetic field. When a receiver coil is placed in the time-varying magnetic field, the magnetic field induces an alternating current in the receiver coil, which can then be used to drive a load. Thus, power is transmitted wirelessly from the transmitter coil to the receiver coil through the time-varying magnetic field.

The induced electromotive force (EMF) is parameter in IPT systems which provides valuable information on the interaction between the primary coil of the WPT device and the environment. However, the parameter cannot be directly measured. Faults or foreign objects may cause deviations from the expected induced voltage. Foreign objects can experience unwanted inductive heating if they are within wireless power transmission range. A foreign object may be described as an object which draws power from a WPT system and/or detunes the system with no useful output. Foreign objects are sometimes also referred to as parasitic objects, because currents induced in the foreign object reduce the efficiency of the system (e.g. by consuming power through Joule heating) with no useful output.

For example, if a coin is placed on a wireless power transfer device, induced eddy currents in the coin will cause the coin to heat up. This heating effect draws power which could otherwise have been used e.g. to charge an electronic device, and can cause discomfort or even burns if the coin is handled. There are in fact two safety concerns with existing WPT systems: the specific absorption rate (SAR) and the inductive heating effects of the generated magnetic and electric fields, e.g. in the coin. A foreign object such as a compact disk which contains a thin metal structure within plastic will heat up even further when exposed to a WPT system.

It is therefore desirable to provide WPT systems capable of accurately estimating the induced EMF.

Prior researchers have considered determining whether or not a foreign object is present within wireless power transfer range of a wireless power transfer device, however these methods to date have been dependent on observing an entire voltage waveform associated with the wireless power transfer device. These methods have been able to make such a determination to a high level of accuracy and confidence by analysing the entire voltage waveform. However, there is room for still further improvements, for example to allow for the possibility of building an integrated system that can estimate the induced EMF without high-performance instrumentation.

The present invention seeks to address these and other disadvantages encountered in the prior art by providing an improved method of determining a magnetically induced voltage on a coil of a wireless power transmission device.

### SUMMARY

An invention is set out in the independent claims. Optional features are set out in the dependent claims.

According to an aspect, there is provided a method of determining a magnetically induced voltage on a coil of a wireless power transmission device. The method comprises: supplying DC input power to the wireless power transmission device; monitoring a first variable associated with the wireless power transmission device; monitoring a second variable associated with the wireless power transmission device, wherein at least one of the first and the second variable is derived from a switching waveform. The method further comprises determining, based on at least one of the first variable, the second variable, and the relationship between the first variable and the second variable, the magnetically induced voltage on the coil of the wireless power transmission device.

The method may further comprise determining, based on the magnetically induced voltage, whether a foreign object is present within wireless power transmission range of the wireless power transmission device.

The method may further comprise, in response to determining that a foreign object is present within wireless power transmission range of the wireless power transmission device, reducing or interrupting a power supply to the wireless power transmission device.

Monitoring a first variable associated with the wireless power transmission device may comprises extracting at least one harmonic from the switching waveform, wherein the first variable is associated with the at least one extracted harmonic.

The first variable may be at least one of: an amplitude of a first (fundamental) harmonic of the switching waveform; an amplitude of a second harmonic of the switching waveform; and an amplitude of a third harmonic of the switching waveform.

Monitoring a second variable associated with the wireless power transmission device may further comprise extracting at least one harmonic from the switching waveform, wherein the second variable is associated with the at least one extracted harmonic.

The second variable may be at least one of: a phase difference between the first (fundamental) harmonic of the switching waveform and the second harmonic of the switching waveform; and an input current.

The at least one harmonic may be extracted using a bandpass filter.

There may be an inverter associated with the wireless power transmission device.

The inverter may be one of: a class EF inverter; a class E inverter; and a class phi-2 inverter. The inverter may be one of: a single ended inverter; and a push-pull inverter.

The switching waveform may be a drain voltage waveform, or a filtered version of the drain voltage waveform.

The inverter may be a class EF inverter and the switching waveform may be an EF branch capacitor voltage waveform.

The first variable may be indicative of an imaginary component of the magnetically induced voltage, and wherein the second variable may be indicative of a real component of the magnetically induced voltage.

The first variable may be indicative of a reactive power transferred between a transmitter and a receiver of the wireless power transmission device and the second variable may be indicative of a real power wirelessly transmitted by the wireless power transmission device.

Monitoring at least one of the first and the second variable derived from the switching waveform may comprise sub-sampling the switching waveform, wherein sub-sampling consists of performing measurements at a frequency that is an integer multiple of a switching frequency of the switching waveform.

According to another aspect of the present disclosure, there is provided a wireless power transmission system, comprising a wireless power transmission device for wirelessly transmitting power to an electronic receiver device and at least one processor configured to perform the above method.

### FIGURES

Specific embodiments are now described, by way of example only, with reference to the drawings, in which:

FIG. 1 a circuit diagram of two bidirectional Class EF inverters with the loads modelled as dependent voltage sources.

FIG. 2 is a flow chart of the steps involved in determining the magnetically induced voltage on a coil of a wireless power transmission device.

FIG. 3 is a flow chart of the steps involved in determining a magnetically induced voltage on a coil of a wireless power transmission device, when there is a Class EF inverter associated with the wireless power transmission device.

FIGS. 4A and 4B depict the output variables plotted against the input current (i_{dcA}) and the amplitude of the fundamental harmonic (H₁).

FIGS. 5A and 5B depict theoretical waveforms of a load-independent Class EF inverter from zero to 20V induced EMF for drain voltage (v_{ds}) and filtered drain voltage (v_{c2}).

FIG. 6 depicts a comparison of the original v_{c2} waveform obtained from a scope and the reconstructed v_{c2} waveform obtained with the sub-sampling method.

FIG. 7 depicts the amplitude of harmonics 1 to 7 of the drain voltage v_{ds} and EF branch capacitor voltage v_{c2} waveforms normalised to sum of harmonics amplitude.

FIG. 8 depicts a crystal characterization setup.

FIG. 9 depicts a simplified circuit diagram of a harmonics extraction board where v_{c2}′ is a scaled version of v_{c2}.

FIG. 10 depicts a phasor chart representing the obtained Dc-DC efficiency for different v_{M} values.

FIG. 11 depicts cross correlation of the time points (feature indexes) and mean of the features in v_{ds}. FIG. 11a is the absolute value of cross-correlation (|G|) of v_{ds} dataset features to dataset features. FIG. 11b is the absolute value of correlation (|G|) of v_{ds} dataset features to v_{M} components. FIG. 11c is the mean of the features of v_{ds} in the time domain and their associated variance.

FIG. 12 depicts cross correlation of the time points (feature indexes) and mean of the features in v_{c2}. FIG. 12a is the absolute value of cross-correlation (|G|) of v_{c2} dataset features to dataset features. FIG. 12b is the absolute value of correlation (|G|) of v_{c2} dataset features to v_{M} components. FIG. 12c is the mean of the features of v_{c2} in the time domain and their associated variance.

FIG. 13 depicts the absolute value of cross-correlation (|G|) of DC dataset features (i_{dcA} transceiver's input current, H₁ amplitude of first harmonic in v_{c2}, H₂ amplitude of second harmonic in v_{c2}, PH₁2 phase between first and second harmonic in v_{c2}). FIG. 13a is the cross-correlation between DC dataset features. FIG. 13b is the correlation of measured DC dataset features with v_{M} components.

FIG. 14 depicts a phasor chart on magnitude of prediction error in i_{dcA}-H₁ model.

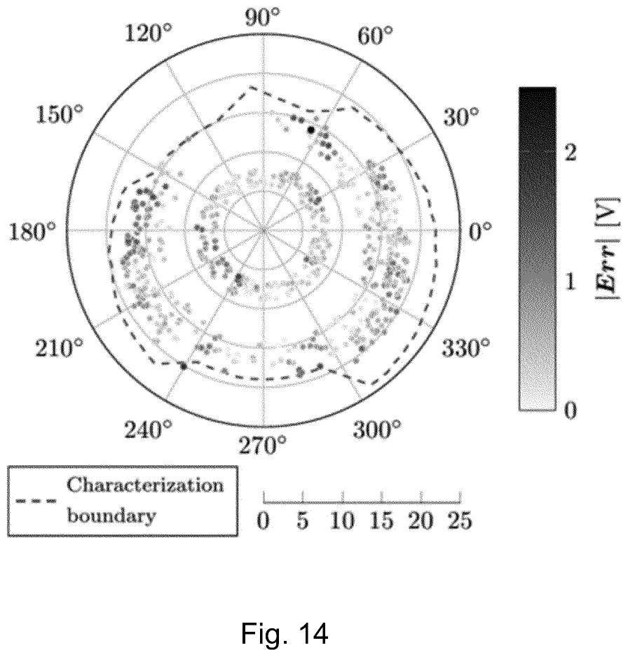

FIG. 15 depicts a phasor chart of the proposed FOD strategy based on definition of an operating region.

FIG. 16 depicts model predictions for detection of a salt water container at different distances. FIG. 16a is an induced voltage prediction (10 samples average). FIG. 16b is detection accuracy with a single measurement (10 samples average).

### DETAILED DESCRIPTION

At the highest level, the present application relates to a method of determining a magnetically induced voltage on a coil of a wireless power transmission device by monitoring two variables associated with the wireless power transmission device, wherein at least one of these variables is derived from a switching waveform.

The present disclosure relates to determining a magnetically induced voltage on a coil of a wireless power transmission device by monitoring two variables associated with the wireless power transmission device. Based on at least one of the first variable, the second variable, and the relationship between them, a magnetically induced voltage can be determined. The present approaches allows for the accurate estimation of the induced voltage based on only two variables.

In particular, the variables may be related to the switching signal (drain) of an inverter or active rectifier through the behaviour of passive components (in this case L2 and C2), for example in an Class EF inverter. Derived from is used here to mean that the variables are related to the switching signal.

These key variables may include the amplitude of a fundamental harmonic of a switching voltage, the amplitude of a second harmonic of the switching voltage, a phase difference between these two harmonics, and the input current. These variables may be obtained with analogue filters and basic digital circuits such as flip flops. The fundamental harmonic may also be referred to as the first harmonic.

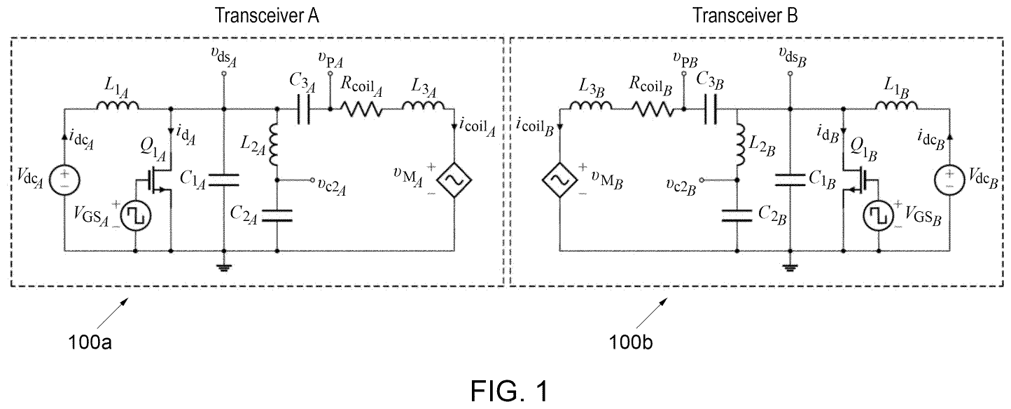

FIG. 1 depicts a circuit diagram of a first transceiver, transceiver A 100a and a second transceiver, transceiver B 100b. The transceivers may form part of respective wireless power transmission devices. Transceiver A 100a and transceiver B 100b are class EF inverters. In particular, transceiver A 100a and transceiver B 100b are bidirectional Class EF inverters. In FIG. 1, the transceiver loads are modelled as dependent voltage sources. In other words, each transceiver is capable to both receive wireless power (receiving mode) and to transmit wireless power (transmitting mode). Either transceiver may be able to receive and store wireless power and then subsequently transmit power to another receiving device.

The skilled person will understand the structure and features of the circuits based on the circuit diagrams of FIG. 1. Both transceivers 100a, 100b comprise a first inductor L₁, a second inductor L₂, and a third inductor L₃, and a first capacitor C₁, a second capacitor C₂, and a third capacitor C₃. Both transceivers 100a, 100b comprise a coil, represented in the circuit as resistance R_{coil}. The primary coil has a current i_{coil} and a voltage vₚ. The induced voltage on transceiver A is represented by v_{MA} and cannot be directly measured. However, the induced voltage v_{MA} can be determined in the manner described herein. DC input power may be supplied to the transceiver with a DC input current i_{dc} and input voltage V_{dc}.

The drain voltage of transceiver A is depicted by v_{dsA} and the drain voltage of transceiver B is depicted by v_{dsB}. A source-drain voltage waveform may be measured at a drain of a transistor, represented by Q1A in circuit A and Q1B in circuit B. The transistor may, for example, be a field effect transistor. The transistor current is represented by i_{d} and there is a gate to source voltage V_{GS} which is the driving signal at the output of the gate drive. The EF branch capacitor voltage of transceiver A is depicted by vc_{2A} and the EF branch capacitor voltage of transceiver B is depicted by vc_{2B}. A drain voltage waveform and an EF branch capacitor voltage waveform are both examples of switching waveforms.

In use, transceiver A may be used to transfer power wirelessly to transceiver B, or vice versa.

### A. FOD

Foreign object detection (FOD) in kilohertz IPT systems may be tackled by either employing external sensors or performing system parameter readings. Using sensors can add significant size and cost to the system, but can ensure high performance even for objects that are distant from the link, ensuring compliance with emissions standards. Previous attempts to make use of system parameter readings, for example the measurement of electrical quantities which vary when a foreign object is in close proximity of the coil, such as efficiency, input current, power loss and equivalent quality factor of the coil, have encountered several problems Employment of these techniques in HF-IPT is difficult and comes with limitations as will now be discussed.

Assuming a fixed output power and expected system efficiency, the input current can be used to estimate if there is a deviation from the expected input power because of the additional eddy currents in a metallic object coupled with the primary or the secondary. One of the main drawbacks of this prior method based on input current reading is that it only works for fixed output power: this can be disadvantageous in HF-IPT systems, since two of the key advantages are dynamic operation and tolerance to multiple loads.

A more accurate method which is based on the same principle is the prior power-loss method: it is possible to estimate if a foreign object is coupled to either side of the system by reading the input current of the transmitter and the output current of the receiver. When the difference between input and output power exceeds a threshold, this indicates that additional power is drawn as a consequence of a foreign object being in proximity of the link. While this method can be practically implemented in several applications, it requires communication between transmitter and receiver, which adds another degree of complexity to the system.

Another possible technique for FOD involves measuring the variation in equivalent quality factor of the transmit coil to infer the presence of coupled receivers or foreign objects. While detecting a variation of quality factor is a feasible FOD method at low frequencies, the Q-factor of the coils used in HF-IPT systems are typically higher than 500, making it difficult to perform a reliable measurement.

### B. FOD Through Induced Voltage Estimation

The effect of external objects on the primary can be modelled as a voltage source representing the induced voltage in series with the transmitter coil. Knowledge of the real and imaginary components of the induced voltage from other circuits or objects can allow detection of deviations from typical operation. This also enables the possibility of detecting tuning mismatches between primary side and secondary side, which can be used in multi-coil systems and active systems to adjust the power flow by changing the relative phases of the coils currents of the transceivers. For the aforementioned reasons it is advantageous to gather information on the induced voltage through a solution which is integrated in the IPT system.

Measuring the induced voltage in a HF-IPT system comes with several practical challenges. In mid-power applications, the voltage across the primary coil can approach the kilovolts range, making it difficult to be probed directly. Any instrumentation added across the primary coil would lead to detuning, since at these frequencies even several picofarads can alter the resonant point of the link.

It is possible to estimate the induced voltage on the primary while knowing the magnitude and phase of the current in the primary and secondary coils, their self-inductances and mutual coupling, however this would require simultaneously probing both sides and using high-performance active current probes for the measurement. This knowledge can however be used to infer a relationship between other measurable variables of the system and the induced voltage on the primary side.

New electrical-parameter-based techniques for FOD in HF-IPT systems have been proposed: a variation in the induced voltage on the primary is inferred based on the shape of the switching waveforms of the transceiver. These techniques show promising results (the normalised RMSE is lower than 2%), but they are difficult to implement in a deployed system since the waveforms are recorded using high-performance oscilloscopes.

This issue can be overcome using the methods based on sub-sampling or interpretation of the harmonic content of the switching waveform as described herein, allowing for cost-effective deployment of this technique for HF-IPT systems.

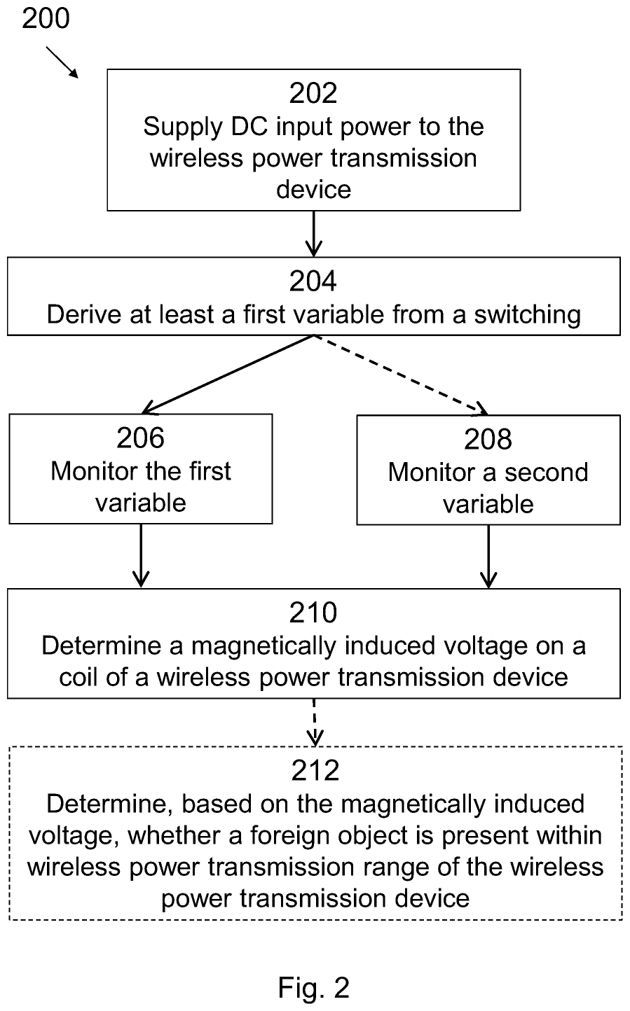

FIG. 2 depicts an example method (200) according to the present disclosure. FIG. 2 depicts a flow chart of steps involved in determining a magnetically induced voltage on a coil of a wireless power transmission device, such as the coil on of the transceivers 100a,b depicted in FIG. 1.

At block 202, DC input power is supplied to the wireless power transmission device. With reference to FIG. 1, power may be supplied to transceiver A with a DC input current i_{dcA} and input voltage V_{dcA}. As FIG. 1 depicts a bidirectional system of two transceivers, power may alternatively be supplied to transceiver B with a DC input current i_{dcB} and input voltage V_{dcB}. The wireless power transmission device may be associated with and/or comprise an inverter, for example one of the transceivers 100a, 100b depicted in FIG. 1.

The inverter associated with and or comprised within the wireless power transmission device may comprise one of: a class EF inverter; a class E inverter; and a class phi-2 inverter. The skilled person would understand that the circuit diagram of FIG. 1 may be adapted to represent a class E inverter by removing L₂ and C₂. To tune a class E inverter, the values of C₃ and L₃ may be set to resonant frequency and C₁ may be adjusted to achieve zero voltage switching at turn-on. Similarly, the diagram of FIG. 1 may be adapted to represent a class phi-2 inverter by adjusting the values of the components. The value of L₁ may be lowered to grant another degree of freedom in the tuning of the inverter.

At block 204, at least a first variable is derived from a switching waveform. Optionally, a second variable is also derived from the switching waveform.

The switching waveform may be a drain voltage (v_{ds}), which may be measured at a drain of a transistor associated with the wireless power transmission device. The transistor may be part of an inverter supplying power to the wireless power transmission device. The voltage waveform may alternatively be measured at other points (other than the transistor drain) within the inverter. With reference to FIG. 1, the drain voltage of transceiver A is depicted by v_{dsA} and the drain voltage of transceiver B is depicted by v_{dsB}.

Alternatively, the switching waveform may be a filtered version of the drain voltage. Preferably, an EF branch capacitor voltage (v_{c2}) can be measured, and it is a filtered version of the drain voltage. In other words, when the signals are analysed in the frequency domain, there is a fixed transformation of the amplitude and phase of each harmonic. Since a filter (L₂C₂) gives a constant transformation, the same information may be derived from both waveforms.

The first variable derived from a drain voltage waveform is monitored at block 206. It may be derived from a filtered version of the drain voltage waveform. The second variable is also monitored at block 208. It can optionally be derived from a switching waveform. For example, the switching waveform may be a drain voltage waveform (or a filtered version of it such as an EF branch capacitor voltage waveform).

Monitoring a first variable associated with the wireless power transmission device may optionally comprises extracting at least one harmonic from the switching waveform, wherein the first variable is associated with the at least one extracted harmonic. For example, the first variable may be the amplitude of a first (fundamental) harmonic, the amplitude of a second harmonic, or the amplitude of a third harmonic extracted from the switching waveform.

Similarly, monitoring a second variable associated with the wireless power transmission device may optionally comprise extracting at least one harmonic from the switching waveform, wherein the second variable is associated with the at least one extracted harmonic. For example, the second variable may be the phase difference between the first (fundamental) harmonic and the second harmonic.

As an example, the first variable may be the fundamental harmonic and the second variable may be the phase difference between the fundamental harmonic and the second harmonic. In that case, both the fundamental and the second harmonic may be extracted from the switching waveform in order to monitor those variables.

Extracting the variables uses simple and cost-effective hardware which are therefore suitable for integration into wireless power transfer systems. This involves less processing time than measuring the entire switching waveform and is therefore more efficient.

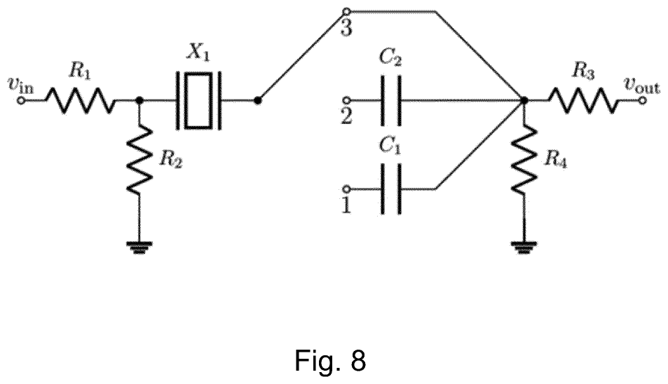

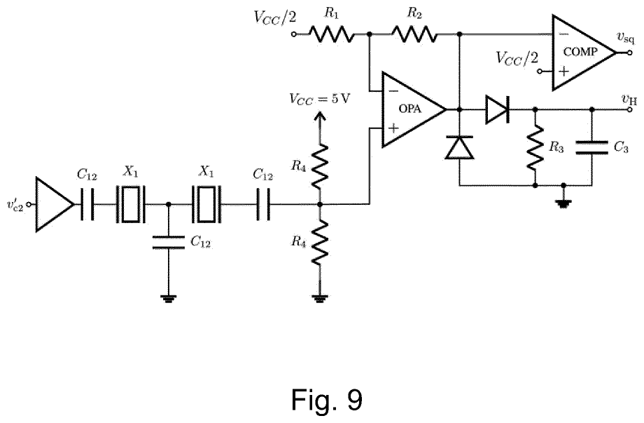

The variables may be extracted using a filter, for example bandpass filters. The filter response may be close to unity gain in a very narrow band at the frequency of the desired harmonic. Using a second order quartz-crystal bandpass ladder filter can achieve an extremely flat response for narrow passbands, and therefore may be a suitable filter type for this application. FIG. 8 depicts three different RC combinations at the output of the bandpass ladder filter. By measuring the frequency of resonance, it is possible to estimate the series inductance, series capacitance, and parallel capacitance of the crystal. The filtered waveform may then be amplified if necessary, as depicted in FIG. 9. The two harmonics may then be compared to a reference voltage to produce a 50% duty cycle square wave operating at the same frequency and phase as the original signal. The two square waves may be used in a flip-flop circuit to output a square wave representing the time delay between the rising edges of the two harmonics. The resulting waveform may be filtered to obtain a DC value representing its average, which is directly proportional to the phase between the two harmonics. The circuits depicted in FIGS. 8 and 9 are simple and cheap to integrate into a wireless power transfer system.

The harmonics can be extracted simply and cost-effectively using a bandpass filter and a peak detector, an example of which is shown in FIG. 9, where X₁ and X₂ are crystal oscillators connected to a scaled version of v_{c2} obtained through a potential divider, which is provided through a buffer. X₁ and X₂ resonate at the same switching frequency of the inverter or a multiple of it when extraction of harmonics of higher order than the fundamental is needed. The capacitors C₁₂ are used to provide the bandwidth and gain of the filters around the resonant frequency. This is then amplified (if needed) using a non-inverting amplifier. The output of such amplifier is passed through a peak-detector to obtain the amplitude of the relevant harmonic. The skilled person will appreciate that the amplitude might be determined through other means such as mixing.

Where a variable is derived from a switching waveform, monitoring may comprise sub-sampling the switching waveform. In other words, performing measurements at a frequency that is an integer multiple of a switching frequency of the switching waveform.

At block 210, the first variable, the second variable, or a relationship between them, may be used to determine the magnetically induced voltage on the coil of the wireless power transmission device.

Determining the magnetically induced voltage may involve determining the imaginary component of the magnetically induced voltage based on the first variable and determining the real component based on the second variable.

The first variable may be indicative of the imaginary component of the magnetically induced voltage. The first variable may further be indicative of reactive power on the coil. In other words, it may be indicative of reactive power transferred between a transmitter and a receiver of the wireless power transmission device. The wireless power transmission device may comprise two transceivers, as shown in FIG. 1, where one will function as a transmitter and the other as a receiver. There may be correlation between the first variable and the imaginary component of the magnetically induced voltage.

The second variable may be indicative of the real component of the magnetically induced voltage. The second variable may further be indicative of real power wirelessly transmitted by the wireless power transmission device. There may be correlation between the second variable and the real component of the magnetically induced voltage.

Therefore, the magnetically induced voltage, which may comprise both a real and an imaginary component, may be determined from the first variable (correlated or otherwise related to the imaginary component), the second variable (correlated or otherwise related to the real component), or the relationship between the first variable and the second variable. The relationship between the first variable and the imaginary component, and the second variable and the real component may depend on the specific circuit.

Determining the magnetically induced voltage on the coil of the wireless power transmission device may optionally include calibrating the system. Calibration may involve a reference induced voltage (calculated knowing the coupling between coils, their inductance and their currents) being compared with a prediction from monitoring the first and second variable. Further calibration may be carried out by measuring the reflected impedance of a given object (such as a metal disk) at a fixed coupling from the receiver coil with an impedance analyser. The reflected impedance may be obtained by dividing the induced voltage by the coil current's amplitude. These values can be compared with the prediction from monitoring the first and second variable, and repeated for different coupling factors, for example using aluminium and steel disks of different diameters.

The first variable may be the amplitude of a fundamental harmonic of a drain voltage waveform (or a filtered version of it). Alternatively, the first variable may be the amplitude of a second or third harmonic of the drain voltage waveform (or a filtered version of it). The second variable may be the phase difference between the fundamental harmonic and the second harmonic. Alternatively, the second variable may be the DC input current.

The magnetically induced voltage may arise due to the presence of a foreign object. A foreign object is defined as an object which draws power from a WPT system and/or detunes the system with no useful output. Foreign objects are therefore sometimes referred to as parasitic objects, because currents induced in the foreign object reduce the efficiency of the system (e.g. by consuming power through Joule heating) with no useful output. The expected magnetically induced voltage is real and positive for a transceiver sending power. Deviations from the expected induced voltage may be caused by faults or foreign objects

Optionally, it may be determined at block 212 whether or not a foreign object is present within wireless power transmission range of the wireless power transmission device based on the magnetically induced voltage. A foreign object may be a moving object or a living object. The wireless power transmission range may be a practical wireless power transmission range, as determined by the errors associated with the measurements. The wireless power transmission range may be defined by a power transfer efficiency threshold. This efficiency threshold may be determined by the practical application of the wireless power transfer system. For example, some applications may require high power and may have a high efficiency requirement and a short range as determined by the efficiency threshold (for example, in electric cars). Alternatively, some applications may require less power and can tolerate a longer range as determined by the efficiency threshold (for example, sensors within a factory environment).

If the imaginary component of the induced voltage is higher or lower than expected, then that may indicate the presence of a foreign object. The imaginary component of the magnetically induced voltage may also give further information about the foreign object, for example a positive voltage may indicate capacitive behaviour and a negative voltage may indicate inductive behaviour. The magnetically induced voltage may also be used to determine the state of tuning.

Optionally, in response to a foreign object being detected within wireless power transmission range, the power supply to the wireless power transmission device may be reduced or interrupted. Being able to detect foreign objects and adjust the power to the system accordingly can prevent power transfer to foreign objects, in order to improve wireless power transfer efficiency, safety and circuit protection.

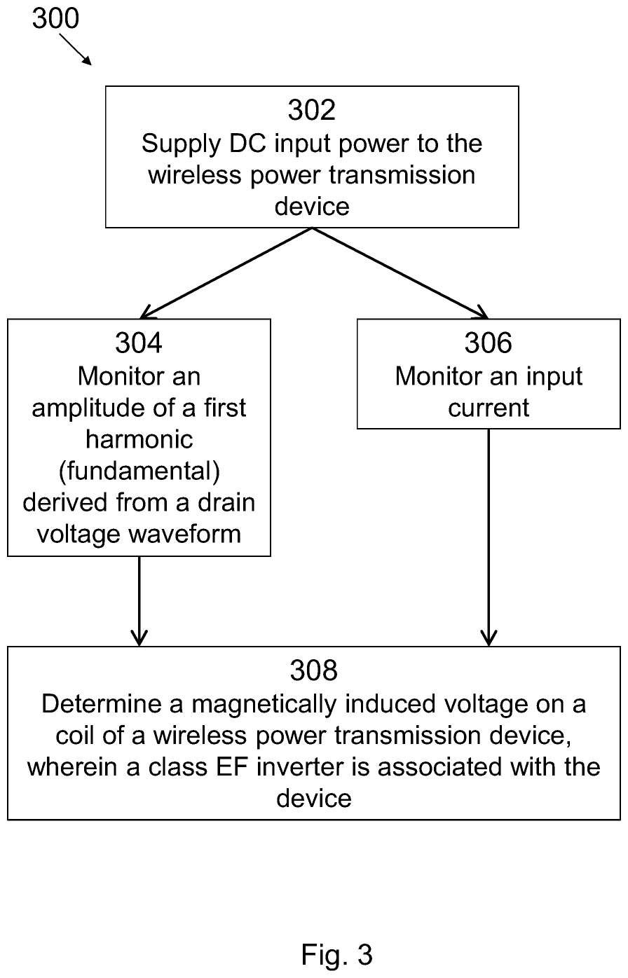

FIG. 3 depicts a flow chart of the steps involved in determining a magnetically induced voltage on a coil of a wireless power transmission device, when there is an inverter associated with the wireless power transmission device and that inverter is a Class EF inverter.

At block 302, DC input power is supplied to the wireless power transmission device. With reference to FIG. 1, power may be supplied to transceiver A with a DC input current i_{dcA} and input voltage V_{dcA}. As FIG. 1 depicts a bidirectional system of two transceivers, power may alternatively be supplied to transceiver B with a DC input current i_{dcB} and input voltage V_{dcB}.

An amplitude of a fundamental harmonic derived from a switching waveform is monitored at block 304.

As discussed in relation to FIG. 2, the switching waveform may be a drain voltage (v_{ds}) measured at a drain of a transistor associated with the wireless power transmission device. The transistor may be part of an inverter supplying power to the wireless power transmission device. The voltage waveform may alternatively be measured at other points (other than the transistor drain) within the inverter. With reference to FIG. 1, the drain voltage of transceiver A is depicted by v_{dsA} and the drain voltage of transceiver B is depicted by v_{dsB}. Alternatively, the switching waveform may be an EF branch capacitor voltage (v_{c2}) waveform which is a filtered version of the drain voltage. It may be measured across the capacitor in the EF branch.

The fundamental harmonic may be extracted from the switching waveform. It may be extracted using filters such as bandpass filters. As previously discussed, FIG. 9 depicts a bandpass filter and peak detector, where X₁ and X₂ are crystal oscillators which resonate at the same switching frequency of the inverter or a multiple of it when extraction of harmonics of higher order than the fundamental are needed. Alternatively, the amplitude may be obtained through other means such as mixing.

Alternatives to measuring the amplitude of the fundamental harmonic include measuring the amplitude of the second or third harmonic derived from the switching waveform. The second and third harmonic may also be extracted from the switching waveform, and their amplitude determined.

An input current is monitored at block 306.

This input current is a current associated with the DC power supplied to wireless power transmission device. With reference to FIG. 1, the input current is depicted by i_{dc}. It directly correlates with the real power delivered by the transceiver.

An alternative to measuring the input current includes measuring a phase difference between the fundamental harmonic and the second harmonic derived from the switching waveform.

At block 308, the amplitude of the fundamental harmonic, the input current, or the relationship between them, may be used to determine the magnetically induced voltage on the coil of the wireless power transmission device, wherein a class EF inverter is associated with the device.

The amplitude of the fundamental harmonic strongly correlates with the imaginary part of the induced voltage and the input current strongly correlates with the real part of the induced voltage (as the input current is directly proportional to the real power delivered to a load). These correlations have not been appreciated in the art to date, and this new, previously unsuspected correlation is advantageous as it allows the magnetically induced voltage on a coil of a wireless transmission device to be determined in the manner described herein.

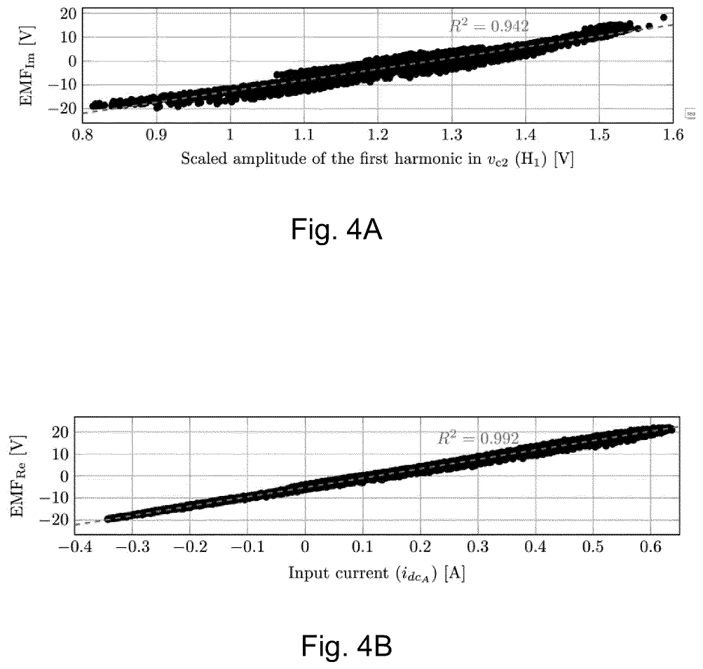

FIG. 4a is a graph depicting the correlation between the amplitude of the fundamental harmonic and the imaginary part of the induced voltage. The x axis depicts the scaled amplitude of the first harmonic of the EF branch capacitor voltage waveform v_{c2} (H₁) measured in volts. The y axis depicts the imaginary component of the induced voltage EMF_{Im} measured in volts.

FIG. 4b is a graph depicting the correlation between the amplitude of the input current with the real part of the input current. The x axis depicts the input current i_{dcA} measured in amps. The y axis depicts the real component of the induced voltage EMF_{Re} measured in volts. A regression model may be used to obtain a relationship between variables and the real and imaginary parts of the induced voltage.

The magnetically induced voltage can be determined by measuring variables that have a substantially linear relationship with the real and imaginary parts of the induced voltage. For a class EF inverter, the real part of the induced voltage is linear with respect to the input current and the imaginary part of the induced voltage is linear with respect to the amplitude of the fundamental of the switching waveform (in particular, the EF branch capacitor voltage waveform). As can be seen on FIG. 4A, the relationship between the imaginary part of the induced voltage (EMF_{Im}) and the scaled amplitude of the first harmonic of the EF branch capacitor voltage (v_{c2}) is described by:

$$y = 46.38 x - 59.04 \qquad ( 1 )$$

Similarly, as can be seen on FIG. 4B, the relationship between the real part of the induced voltage (EMF_{Re}) and the input current (i_{dcA}) is described by:

$$y = 42.55 x - 5.18 \qquad ( 2 )$$

Alternatively, the inverter may be a class E inverter or a class phi-2 inverter. The first variable may similarly be at least one of: the amplitude of the fundamental harmonic, the amplitude of the second harmonic, and the amplitude of the second harmonic. The second variable may similarly be at least one of: the input current, and the phase difference between the fundamental harmonic and the second harmonic.

In relation to FIG. 2, the second variable may be a DC input current which may be measured using a simple current sense resistor or more advanced techniques (for example, Hall-sensors and fluxgates). The second variable may alternatively be the phase difference between the amplitude of the fundamental harmonic and the amplitude of the second harmonic.

The presently disclosed methods are advantageous. In general, one of the advantages of high frequency inductive power transfer (HF-IPT) systems is the high tolerance to misalignment and large air-gaps. However, the inherently large magnetic field volumes can lead to coupling of additional foreign objects with the primary, e.g. with the transmitting coil, causing possible detuning of the system and heating of the objects. These foreign objects and the conditions of the local environment can load the transmitter, which changes the induced voltage on the primary side. Unfortunately, the induced voltage is not directly measurable in an operating transmitter and the most straight-forward previously known way of calculating this variable, through a measurement of primary coil current and voltage, can cause a significant decrease in quality factor which reduces system performance. An integrated solution capable of estimating the induced voltage through other less invasive measurements in the primary is needed to ensure safety of operation through foreign object detection (FOD). Knowledge of the induced voltage can also be used to correct tuning mismatches where both sides of the link are active (i.e. in synchronous rectification and bidirectional systems). Multiple candidate variables for estimating the induced voltage are assessed based on factors such as measurement practicality and estimation accuracy.

The present inventors have determined for the first time that a solution which is based on the measurement of only two variables, for example, the amplitude of the fundamental frequency of the switching waveform and input current, can achieve state-of-the-art induced voltage estimation accuracy. These two variables, which can be obtained using simple cost-effective analogue circuitry, may be used in a Gaussian process to generate a regression model. This may be used to estimate induced voltages. The accuracy of the method has been tested, and in these tests it was determined that the induced voltage may be determined at any angle in an approximate magnitude range of 0 V to 20 V with a normalised root mean square error of 1% for the real part and 1.5% for the imaginary part. This corresponds to detecting a plastic container with 1 kg of saline solution (0.4% concentration, to emulate the electromagnetic profile of muscle) at a distance of 15 cm (1.5 coil radii). The results described below were obtained with a bidirectional Class EF transceiver operating at 13.56 MHz delivering up to 32 W with coupling factors ranging from 1.1% to 4%.

The development of high efficiency HF-IPT systems has enabled wireless charging for new classes of applications in dynamic environments because of the flexibility of systems operating in the megahertz range both from the perspective of low coupling operation and load variations.

While IPT systems which operate at tens and hundreds of kilohertz exploit flux shaping through the presence of ferrite, aiming to mitigate the effect of misalignment on system performance, HF-IPT systems most commonly employ air-core coils, thus generating an unconstrained flux which is dependent on the coil geometry. This achieves larger tolerance to misalignment, eliminating the need of ferromagnetic materials, but it also causes larger energised volumes around the primary, increasing the likelihood of foreign objects coupling with the system.

The presence of foreign objects can lead to undesirable operating conditions, which affect system performance: when a foreign object reflects a reactance to the primary side, the resonant tank gets detuned, and this tends to cause additional losses (heating) in the system. Foreign objects can also heat up, making the environment where the system is operated unsafe for users.

Knowledge of the elements that are coupled to the primary coil is not only advantageous from a safety perspective. Estimating the induced voltage in the primary also allows tuning mismatches between primary and secondary in back-to-back active systems to be detected. Induced voltage estimation can also be used to minimise the reactive element of the reflected impedance by adjusting the relative phase between primary and secondary coil currents when using active receivers.

Previous conceptual findings have suggested that the drain voltage waveform of a Class EF inverter contains the information necessary to deduce the amplitude and phase of the induced voltage of a HF-IPT coil driven by the Class EF inverter. However, the attainment of the estimated amplitude and phase of the induced voltage (v_{M} 1) in the prior method requires high performance oscilloscopes as a fundamental building block, because the entire drain voltage waveform must be measured.

In contrast, the present application describes techniques that can be realized with simple and cost-effective hardware which are therefore suitable for integration into wireless power transfer systems for commercial deployment.

Specifically, the present application describes a technique to perform induced voltage estimations in real time based on the measurements of only two variables (selected following a statistical approach as described herein). This is in contrast with the previous conceptual findings, where the entirety of the time points of a sampled waveform must be used. These two variables (for example, input current and amplitude of the first harmonic of v_{c2} from the diagram in FIG. 1) only change when the link properties are modified i.e. changes in load, coupling or the presence of a foreign object. This technique also makes it possible to overcome issues associated with high frequency noise and sampling jitter, which are inherent of techniques that perform fitting of the entire time domain signal. The disclosed technique does not require high-performance instrumentation, as the entirety of the circuitry for extraction of the relevant signals can be implemented in a system sub-module, with the possibility of miniaturisation and integration in the system without compromising the tuning and the system efficiency.

### Implementing Class EF Transceivers for Bidirectional Wireless Power Transfer

Class EF (FIG. 1) is a coil driver topology that is typically employed in HF-IPT systems due to its high efficiency at MHz frequencies. This topology comes with the advantages of using only one low-side transistor and open-loop operation (constant duty cycle and frequency). This topology can be employed as an inverter or a rectifier: power flow is controlled through the relative phase of the switching signals of the coil drivers, aiming for an angle between coil currents of ±90° to prevent imaginary reflected impedances. The topology is similar to a Class E inverter, but the addition of the L₂, C₂ grants the possibility of waveform shaping, with the option of load independent operation and an overall lower v_{ds} peak voltage.

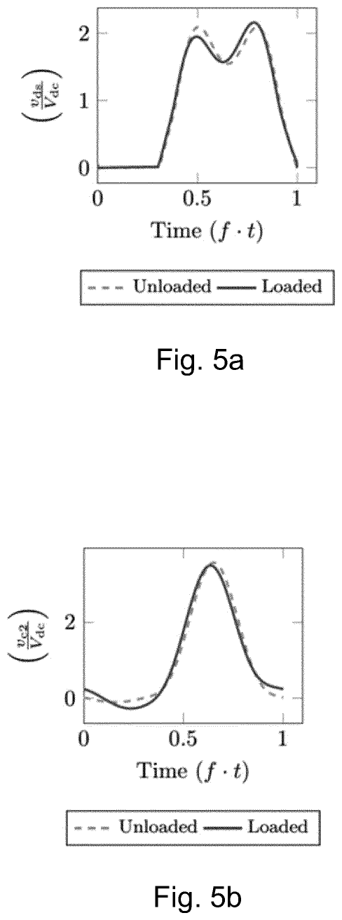

The Class EF inverter presented in this work operates at a fixed frequency of 13.56 MHz and a fixed duty cycle of 30%. The choice of components can be found in Table I below. The theoretical waveforms of this design are shown in FIGS. 5a and 5b.

FIG. 5a depicts a theoretical drain voltage v_{ds} waveform for a load-independent Class EF inverter from zero to 20V induced voltage. The x axis depicts time and the y axis depicts the ratio of v_{ds} over Vac. FIG. 5b depicts a theoretical drain voltage v_{c2} waveform for a load-independent Class EF inverter from zero to 20V induced voltage. The x axis depicts time and the y axis depicts the ratio of v_{c2} over V_{dc}.

From these waveforms it is noticeable that v_{ds} is zero at turn-on for |vM| values of 0 V and 20 V. v_{c2} is a filtered version of v_{ds}, obtained across the capacitor of the EF branch.

TABLE I
COMPONENTS VALUES FOR THE TRANSCEIVERS

| Component | Value | Description |
|---|---|---|
| C₁ (pF) | 100 + Cₒₛₛ | Vishay QUAD HIFREQ |
| C₂ (pF) | 186 | Vishay QUAD HIFREQ |
| C₃ (pF) | 125 | Vishay QUAD HIFREQ |
| L₁ (μH) | 88 | Wurth Elektronik WE-PD |
| L₂ (nH) | 234 | Coilcraft 2014VS |
| Lp & Ls (nH) | 1181 | IPT PCB coils |
| Q₁ | | GS66504B (650 V, 15 A) GaN FET |

A change in v_{M} yields a unique change in both v_{ds} and v_{c2}. This can be inferred by the monotonically increasing behavior of the magnitude and phase components of the main harmonics of v_{ds} and v_{c2} when changing v_{M}: the magnitude components of the harmonics strongly correlate with the imaginary part of v_{M}, while the phase components strongly correlate with the real part of v_{M}.

### Evaluation and Attainment of Electrical Signals in a Class EF Transceiver

The loading state of a transceiver may be defined as the set of electrical parameters that define the behaviour of the system under different loading conditions. This includes load, direction of power flow, losses, and changes in resonant point of the tank. It is possible to assess the loading state of a Class EF transceiver by analysing the currents and voltages of the circuit diagram in FIG. 1.

While most of the parameters marked in the diagram in FIG. 1 are relevant to assess transceiver's loading state, not all of them are practical from an electrical measurement standpoint.

The main variables are discussed as follows:

1) Primary coil current (i_{coil}) and primary coil voltage (vₚ): resonant tank parameters such as Q factor and reflected impedance can be calculated knowing the primary coil current and voltage. Coil current measurements can, however, be unpractical as the introduction of instrumentation can lower the quality factor of the coil: for example in the coils presented in this work an additional series resistance of 100 mΩ would result in a decrease in quality factor of more than 30%. Measuring the voltage across the coil can be challenging as well, since it is not uncommon to observe voltages in the kilovolts range. Probing also introduces an additional capacitance in the resonant tank which can alter the resonant frequency of the tank or change the operating nature of the inverter.

2) Transistor drain current (i_{d}): while it is possible to extract valuable information on the loading state of the inverter from this variable, measuring the drain current introduces an additional series inductance at the drain terminal of the device, which is non-negligible in the typical packaging of wide-bandgap devices, such as GaN.

3) Input current (i_{dc}): the information contained in the input current can be useful, as its average strongly correlates with the real power delivered by the transceiver. Measurements of this variable can be performed with relative simplicity from the system integration standpoint. This can be done either with a current sense resistor or Hall-sensors and fluxgate as reported in the literature.

4) Transistor drain voltage (v_{ds}) and EF branch capacitor voltage (v_{c2}): v_{ds} can provide relevant information for estimation of the state of a transceiver. From v_{ds} it is possible to deduct when the transceiver is operating under sub-optimal conditions (hard-switching or body diode conduction). All this information ties directly with the magnitude and angle of v_{M}, making v_{ds} a high-priority candidate variable for induced voltage estimation. v_{c2} is a filtered version of v_{ds} obtained across the capacitor in the EF branch. Its |dv/dt| is lower than the one of v_{ds}, implying less abrupt changes, but similarly to v_{ds} its behaviour can also provide relevant information on v_{M}.

The introduction of either a voltage probe or instrumentation has little effect on the inverter's tuning: typical ranges of the C1 and C2 capacitances in 13.56 MHz designs are in the hundreds-of-picofarads, while the parasitics introduced by the probes or the instruments are lower than 7.5 pF. This does not cause a deviation of equivalent capacitance at those nodes by more than 10%.

While both waveforms are measurable with a voltage probe without any major adjustments, using instrumentation requires scaling of the waveform. This can be achieved by using a potential divider or alternatively separating the C1 or C2 capacitance into two, achieving an appropriately sized capacitive voltage divider.

Implementing a capacitive voltage divider is more convenient for the measurement of v_{c2}: the additional inductance from splitting the C2 capacitance can be compensated in L₂. However, implementing a capacitive divider to measure v_{ds} is inconvenient: with regards to PCB design it is necessary to minimise the distance between C1 and the transistor to avoid the introduction of parasitic inductance, making the splitting of C1 problematic. The same problem applies for the placement of a sense resistor to use the current through C1 as a source of information. Current sensing in the L₂-C₂ branch is not convenient either, as introducing a current sense resistor would lower the equivalent quality factor of L₂, hindering performance.

It can be concluded that v_{c2} is an overall better candidate to measure via custom instrumentation. However, v_{ds} is also analysed below.

### A. Time Domain Methods

Having established that the focus lies on the waveforms v_{ds} and v_{c2} due to their information content and measurement practicality, it is necessary to establish how to extract and interpret the information contained to estimate the induced voltage.

It has been previously demonstrated that the information in v_{ds} can be used to estimate vM, however all the measurements were performed using 2.5 giga-samples-per-second (GSa/s) oscilloscopes (HDO6104A and HDO4034A from Teledyne LeCroy). From simulation, the minimum re-quired number of samples to capture phenomena such as hard switching and diode conduction is around 150 per cycle, corresponding to 2 GSa/s. In order to make this previous approach more suitable for embedding into real applications, a measurement technique based on sub-sampling may be used. This can be implemented using a low-cost microprocessor (for example a Raspberry PI) controlling a delay module that triggers an ADC conversion.

The process for extracting a periodic time domain waveform (vhf) through sub-sampling consists of performing measurements at a frequency of fₛₐₘₚ=f_{sw}/n, where f_{sw} is the switching frequency and n is an arbitrary integer. In other words, sub-sampling can be achieved by taking measurements at a frequency that is an integer multiple of the switching frequency of the switching waveform. This generates a measurement for a specific point in time within a cycle. By applying a controlled time delay (td) to the trigger waveform generated at fₛₐₘₚ it is possible to move to another point within vhf. For a sufficiently small time-step it is possible to obtain a reconstructed version of vhf. The time resolution of the reconstructed waveform is given by the chosen value of td.

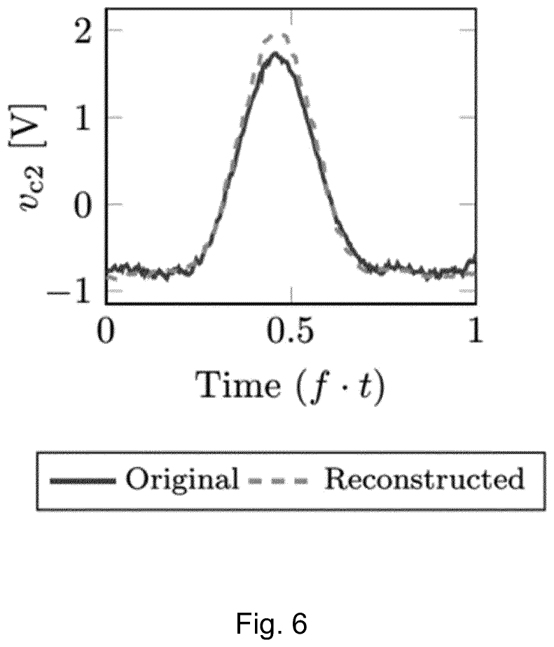

FIG. 6 shows a comparison between the original v_{c2} wave-form extracted from an oscilloscope and its reconstructed version from the sub-sampled Raspberry Pi-based measurement. The x axis depicts time and the y axis depicts v_{c2} measured in volts. The solid line depicts the original waveform and the dotted line depicts the reconstructed waveform. The RMSE normalised to the peak-to-peak of the original v_{c2} is around 1%, indicating a successful retrieval of the waveform through on-board instrumentation. The mismatch in the peak of v_{c2} is likely due to the additional parasitic inductance from the connection of the v_{c2} node to the sub-sampling circuit through a BNC-to-SMA cable.

### B. Frequency Domain Methods

Changes in the induced voltage do not typically occur abruptly as they are caused by a change in load (where the rate of change is limited by the size of the output energy storage system) or a change in position of a foreign object or transceiver with respect to the primary. This means that the loading state of the transceiver remains practically unchanged in a time window during which its switching waveforms can be approximated to a Fourier series.

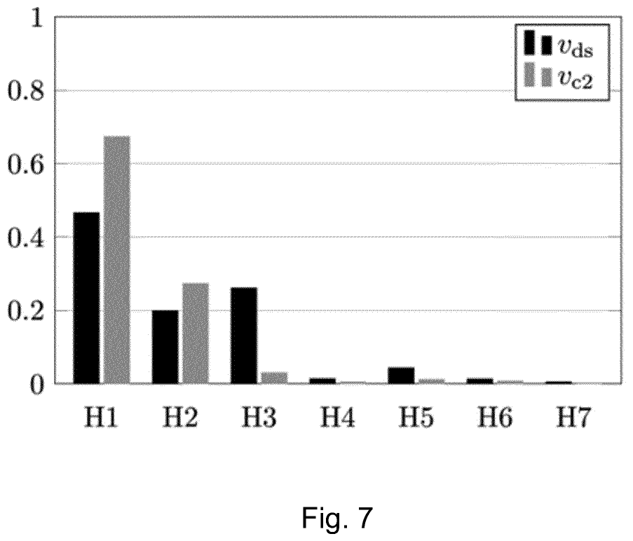

FIG. 7 depicts the amplitude of harmonics 1 to 7 of the drain voltage v_{ds} and EF branch capacitor voltage v_{c2} waveforms normalised to sum of harmonics amplitude. The dark grey bars represent the drain voltage waveform and the light grey bars represent the EF branch capacitor voltage waveform.

In most Class EF inverter designs, the majority of the power (>90% as shown in FIG. 7) is carried by the first, second and third harmonics of the waveforms, and hence in this work the frequency domain analysis is based on these frequencies only. The information contained in only the first and second harmonics is sufficient to perform low error estimations of the induced voltage.

For the extraction of information in the frequency domain it is possible to perform three key steps: harmonics separation, amplitude measurement of the individual sine-waves and retrieval of phase difference. In the present implementation the harmonics are separated with bandpass filters. This requires the filter response to be close to unity gain in a very narrow band at the frequency of the desired harmonic, while achieving high attenuation for the other frequency components of the waveform. Achieving this performance through classic active and passive filter topologies often requires high order filters which have extreme sensitivity to passive components values. The availability of affordable operational amplifiers suitable for filtering in the megahertz range is another constraint. However, using a second order quartz-crystal bandpass ladder filter can achieve a flat response for narrow passbands, making it a suitable filter type for this application.

The bandpass ladder filter is tuned after performing a characterisation of the crystals. Using three different RC combinations at the output of the filter (as shown in FIG. 8) and measuring the frequency of resonance, it is possible to estimate the series inductance, series capacitance and parallel capacitance of the crystal. The filter may be tuned by neglecting the parallel capacitance (Cp) and achieving resonance of the motional inductance (Lm) and the combination of coupling capacitance (C12) and motional capacitance (Cm). Both bandpass filters have an very narrow bandwidth as expected (1-10 kHz), with gains of ≅1 for the fundamental (13.56 MHZ) and ≅0.4 for the second harmonic (27.12 MHz).

As shown in FIG. 9 the filtered waveform is then amplified (if necessary) to give a high enough voltage for the envelope detector to provide a v_{H}>0 under all operating conditions. To extract the 13.56 MHz component, the amplification is set to unity gain, while to extract the 27.12 MHz component it is set to a gain of around 3. The phase difference is extracted using a type II phase detector, whose output is low-pass-filtered to obtain a DC signal.

### Experimental Setup for Gathering Data on the Loading State of the Transceiver

To generate a model that enables predictions of v_{M} for real applications, a set of data may be gathered from the primary transceiver. This may be done using a bidirectional test rig, together with the additional circuits for waveform extraction presented in FIGS. 8 and 9.

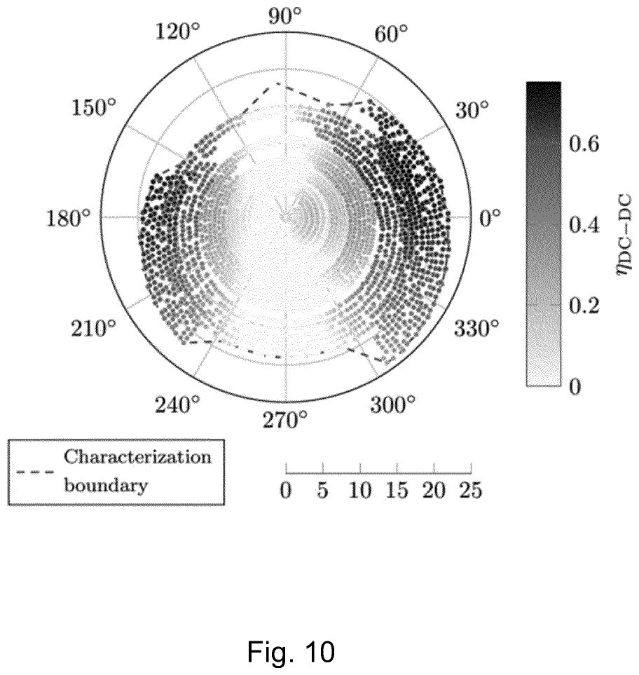

The data are gathered using two identical Class EF transceivers (FIG. 1). The transceiver to characterise, Transceiver A, is kept at a fixed input voltage, while Transceiver B is used to produce a measurable induced voltage onto Transceiver A. The phase (θ) between VGSA and VGSB changes the angle of the induced voltage, while the input voltage of Transceiver B (V_{dcB}) and the coupling between the two coils (k) influence the magnitude of the induced voltage. The phase between the transmitter and receiver side is bounded by the operating region shown in FIG. 10. The phase value is changed in fixed steps of 2.5°. Five different couplings are used: 1.1%, 1.6%, 2.2%, 3.2%, 4%. For the 1.1% coupling case v_{dc} is stepped from 0 V to 80 V in steps of 10 V. For couplings between 1.6% and 4% Vdc goes from 60 V to 80 V in variable steps to obtain an approximate distance between vM samples of 0.5 V to 1.2 V.

With this knowledge it is possible to setup an automated measurement system that sweeps θ and v_{dcB} and gathers simultaneously i_{dcA}, i_{dcB}, v_{dcA}, v_{dcB}, i_{coilA}, i_{coilB}, v_{dsA}, v_{c2A}A and the amplitude of extracted harmonics information from v_{c2} (amplitude of first harmonic H₁, amplitude of second harmonic H₂ and phase between the two PH₁₂). An alternative version of v_{c2} is concurrently extracted through the sub-sampling method as previously described.

A characterisation boundary is determined as shown in FIG. 10 to ensure safe operation of both transceivers under the different loading conditions. The boundary is obtained by setting a maximum transistor temperature of 65° under stable cycle-by-cycle operation. While it is possible to use more stringent sets of rules for setting the boundary, such as looking directly at hard-switching or soft switching conditions or maximum current through the device, temperature and stability are the minimum requirements to ensure safe operation of the system.

3327 points are gathered to generate the different models. As expected, the system's efficiency is maximised (η=72.5%) when the real portion of the induced voltage is maximised and the imaginary portion of the induced voltage is minimised. Whilst it is expected that this would occur for θ=−90°, experiments show that this condition holds for θ=−85°, V_{dcA}=V_{dcB}=80 V. The 5° deviation from the expected value of e can be explained as a slight tuning mismatch between the two sides.

### A Statistical Analysis of Candidate Waveforms for Optimal Model Prediction

In data science, a feature is defined as an individual property of a system which can be used to define the system's characteristics. In this work, the features are individual samples of a waveform in the time domain, or steady values representing information such as input current or amplitudes and phases of the harmonics of the switching waveforms. The approach in previous work relies on extracting four periods of v_{ds} from an oscilloscope and using every sampled point of the waveform as a feature to estimate both real and imaginary components of v_{M}. Here, a reduced model may be built by first analysing the waveforms of the Class EF transceiver operating over the entire load spectrum to determine which features of the waveform carry the most information about v_{M}. Both v_{ds} and v_{c2} may be analysed in the time domain and in the frequency domain and weighted the loading information content using a cross-correlation approach. Features that strongly correlate with the real and imaginary parts of v_{M}, while having low cross-correlation (i.e. redundancy) with each other may be found.

Correlation between two vectors (X and Y) is defined as:

$$\\ \begin{matrix}G {=}^{△} E [ {XY}^{{}_{} {}_{} T} ] & ( 3 )\end{matrix}$$

with E [XY^{T}] being the expectation of the vector product XY^{T}. For the analysis conducted in this work, the magnitude of G may be used, since the negative correlation will only indicate that one variable is decreasing as the other variable increases. These features are then grouped to form datasets that will later be used to generate a regression model used to describe variations of v_{M} under different loading conditions.

### A. Time Domain Analysis

In this section the contribution of these individual features of v_{ds} and v_{c2} is firstly analysed using the correlation approach described above. This section analyses a dataset extracted with an oscilloscope. Since the goal of this section is oriented around the analysis of the information content of the waveforms, the sub-sampling is temporarily omitted to ensure that the analysis is performed on the highest quality data. With this analysis it is possible to assess the presence of regions with high information density, providing a deeper understanding on the effect of v_{M} on specific time windows within a cycle of the switching waveforms.

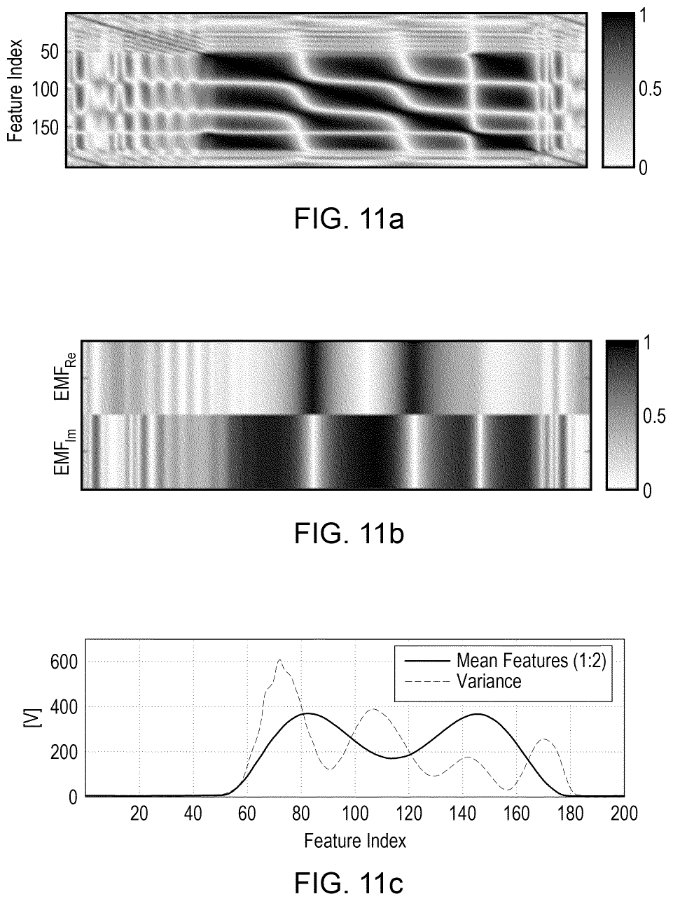

FIG. 11 depicts cross correlation of the time points (feature indexes) and mean of the features in v_{ds}. FIG. 11a is the absolute value of cross-correlation (|G|) of v_{ds} dataset features to dataset features. FIG. 11b is the absolute value of correlation (|G|) of v_{ds} dataset features to v_{M} components. FIG. 11c is the mean of the features of v_{ds} in the time domain and their associated variance.

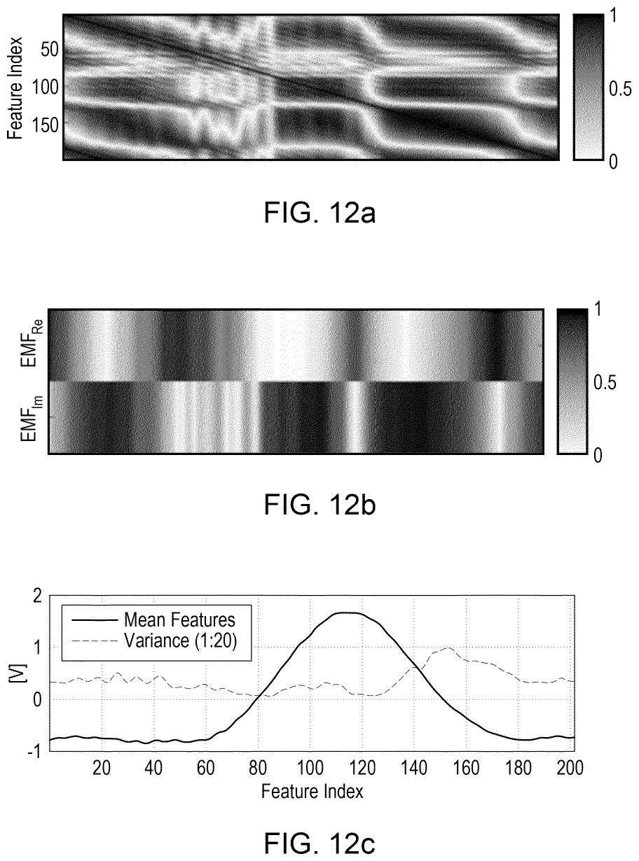

FIG. 12 depicts cross correlation of the time points (feature indexes) and mean of the features in v_{c2}. FIG. 12a is the absolute value of cross-correlation (|G|) of v_{c2} dataset features to dataset features. FIG. 12b is the absolute value of correlation (|G|) of v_{c2} dataset features to v_{M} components. FIG. 12c is the mean of the features of v_{c2} in the time domain and their associated variance.

A key difference in the comparison of the data from the time domain and the frequency domain is continuity of adjacent features: this occurs in the time domain since neighbouring points in a sampled waveform show a degree of correlation. Whilst all the points on the main diagonal from FIG. 11a and FIG. 12a show a cross-correlation of unity (i.e. the points are self-correlated as expected), it is possible to also notice additional points in proximity of the main diagonal which are strongly correlated in both v_{ds} and v_{c2}. The regions in which the main diagonal gets thinner indicate a portion of the waveform where neighbouring features are less correlated. This indicates a non-linear relationship between features in a specific portion of the waveform. If this occurs for features that are meaningful for the output of the model (i.e., high correlation with the real and imaginary components of v_{M}), sampling jitter of the extracted switching waveform will have a noticeable effect on the outcome of the estimation of v_{M}. This problem does not occur in the frequency domain datasets: the harmonic components are independent of sampling jitter, since they are individually extracted as steady values.

It is possible to observe that over the same number of features (i.e. same sampling rate in the same time window), v_{ds} presents a region (when the transistor is on) in which features do not correlate to either EMF_{Im} nor EMF_{Re}, meaning that overall the gathered data contains portions that are not relevant for model generation. Such features will be suppressed in the model.

Another noticeable difference between v_{ds} and v_{c2} is features variance. At turn-off v_{ds} will have a high maximum |dv/dt|, leading to significant changes in a relatively short time window. This translates into a big variation of neighbouring data samples, especially when waveform triggering occurs at slightly different times. v_{c2} variations are typically much smaller due to the presence of the LC combination slowing down its rate of change, making features variance more uniform compared to v_{ds}. This can overall reduce the noise introduced by jitter into the dataset, leading to a more robust model.

While it is possible to trigger measurements focused on regions with a high density of information for the estimation of v_{M} (dark areas in the middle plots of FIG. 11b and FIG. 12b), the maximum correlation of v_{M} with an individual time domain feature in v_{ds} and v_{c2} does not surpass 0.95, suggesting the need of additional features to achieve a performance which is comparable to that of other models presented herein. In Table III, it is shown that an attempt of induced voltage estimation using six samples of v_{ds} in time domain achieves an acceptable performance, but the overall quality of the model is lower compared to most of the other models presented.

It is possible to conclude that the datasets based in the time domain present significant disadvantages that are difficult to overcome: the dataset can be relatively large for a single cycle of the waveform, measurements can be affected by sampling jitter and there is a large degree of redundancy carried by multiple features.

### B. Frequency Domain Analysis

The frequency domain approach poses a valuable alternative to the time domain approach: the sampling jitter problem is eliminated, individual features that are strongly correlated with the output can be selected more easily and the induced voltage estimation time decreases since it is not necessary to iterate through several cycles of the waveform to perform sub-sampling. In this frequency domain approach the total speed depends on the time constant of the lowpass filters used for envelope detection and phase retrieval. The data extracted from the harmonics of v_{c2} are analysed using the same cross-correlation criterion.

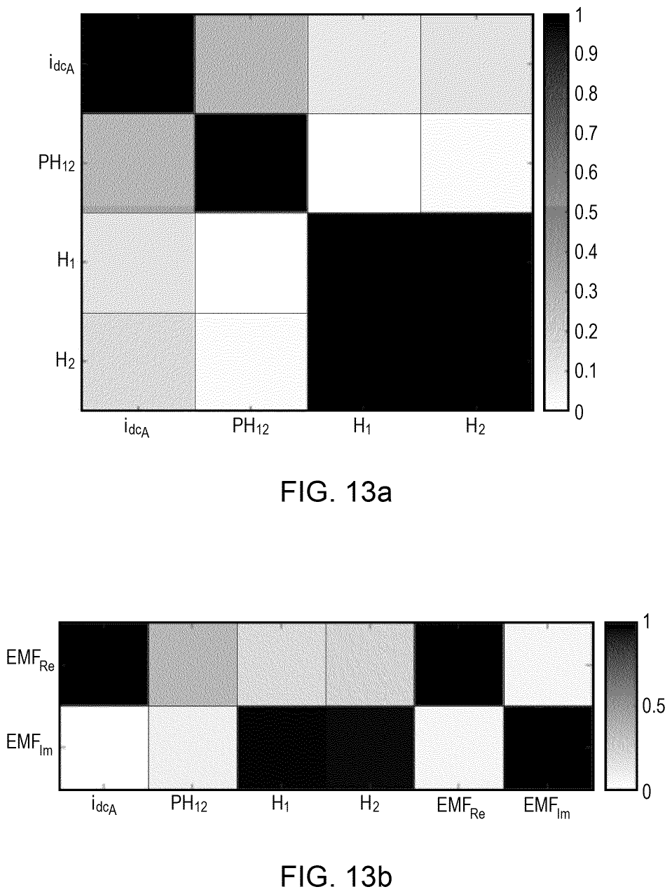

As shown in FIG. 13, the feature in v_{c2} with the strongest correlation with the real part of v_{M} (EMF_{Re}) is the phase between first and second harmonic (PH₁₂). The amplitudes of first and second harmonic (H₁ and H₂ respectively) are good variables for the estimation imaginary part of v_{M} (EMF_{Im}), however the high cross-correlation between them suggests that the presence of both features in a model will carry redundancies (i.e., the information content of the two features is too similar).

In the same cross-correlation matrix, the effect of a feature that is not extracted from v_{c2} may also be analysed: the input current of Transceiver A (i_{dcA}). This feature shows the strongest correlation with EMF_{Re}, making it another suitable variable to perform v_{M} estimations through the model. This is ultimately expected, since the input current is directly proportional to the real power delivered to a load.

When choosing the best set of features it is expected that the pair i_{dcA}-H₁ will outperform the other combinations. This is intuitive when looking at the linear dependency of these features with EMF_{Re} and EMF_{Im} shown in FIGS. 4b and 4a respectively. While it is also possible to use H₂ rather than H₁, or even a combination of the two, the high correlation between them and the stronger correlation between EMF_{Im} and H₁ indicate that H₁ is overall a better variable to estimate EMF_{Im}. H₁ is also easier to extract, since the bandpass filter is easier to tune and has a much smaller attenuation, preventing the need of further amplification before envelope detection.

In the data presented here it should be noted that the cross-correlation between the real and imaginary components of the induced voltage on the primary is close to zero. This occurs because the induced voltage was generated through a controlled bidirectional system, which allowed the angle and the magnitude of v_{M} to be changed independently from each other. When foreign objects are coupled to the transceiver this is not the case: an object with fixed size and electromagnetic properties will induce a voltage with an angle which is almost constant, but with a magnitude that varies depending on coupling. Obtaining a dataset only through the use of foreign objects will introduce some degree of correlation between the real and imaginary components of v_{M}.

### Generation and Evaluation of Models

Eight regression models were generated using different combinations of the extracted datasets, both for the time domain and the frequency domain to obtain a performance comparison. The reported regression models use a Gaussian process as it was observed that this fitting process tended to outperform support vector machines (SVM), linear regressions and regression trees with all the datasets. Model performance was assessed by gathering 600 additional random points at three different couplings: 1.6% (k1), 3.2% (k2) and 4% (k3). k3 is considered an outlier test-set, as the model edge is approached in multiple instances.

### A. Calibration

System training and testing does not guarantee top performance under all conditions. Placing the coil in an environment that is different from the training setup may alter the results. This is because changes in the placement of any metallic objects or even elements in the circuit boards (i.e., heath sinks and connectors) may induce a voltage on the coil during system operation. For this reason a calibration process is required when the system position is altered. An additional set of data is gathered upon operation in the new environment. The reference v_{M} (calculated knowing the coupling between coils, their inductance and their currents) is compared with the predictions from the model. For a large enough set of data, the average error of the model should be centered around zero. When this is not the case it means a systematic offset is introduced by surrounding objects. This offset can be subtracted from the prediction to adapt the model for the new environment.

A further calibration procedure can be performed when a very precise measurement of v_{M} is required. It is possible to measure the reflected impedance of a given object (in this case metal disks as a reference fixture) at a fixed coupling from the receiver coil with an impedance analyzer. The reflected impedance (ZM) is obtained by dividing v_{M} by the coil current. These values are then cross-checked with the prediction of the same object from the model. These measurements are performed for three different coupling factors using aluminum and steel disks of different diameters as shown in Table II. Comparing the measured impedance with the predicted impedance allows fitting of a function that approximates the error with respect to the measured impedance. In the performed experiments the function appeared to be linear. The predicted value can then be scaled according to the function. This allows corrections to be made to variables that are hard-coded in the model (e.g. coil inductance and coupling).

Table II shows impedance estimation results for the calibrated i_{dcA}-H₁ model. The maximum errors (0.122 (in the worst case) are obtained for tests where the reflected impedance on the primary is extremely low, making it difficult to distinguish between an unloaded scenario and the presence of small metallic disks (5 cm diameter) at a distance of 10.2 cm from the primary coil. The standard deviation of the readings does not surpass 25 mΩ. For metallic disks larger than 10 cm in diameter, the reflected impedance is estimated with errors lower than 100 mΩ for separations ranging from 5.1 cm to 15.2 cm.

TABLE II
IMPEDANCE ESTIMATION OF METAL DISKS (M INDICATES MEASURED
IMPEDANCE FROM IMPEDANCE ANALYSER, P INDICATES ESTIMATED
IMPEDANCE FROM THE REGRESSION MODEL)

| Disk | | Distance | | | | |
|---|---|---|---|---|---|---|
| diameter | | from TX | | | | |
| [cm] | Material | coil [cm] | X_{M} [Ω] | X_{P} [Ω] | \|Err\| [Ω] | σ [Ω] |
| 5 | Steel | 5.1 | 0.298 | 0.315 | 0.017 | 0.020 |
| 5 | Aluminium | 5.1 | 0.247 | 0.326 | 0.079 | 0.020 |
| 10 | Steel | 5.1 | 1.789 | 1.700 | 0.089 | 0.025 |
| 10 | Aluminium | 5.1 | 1.789 | 1.744 | 0.045 | 0.017 |
| 5 | Steel | 10.2 | 0.128 | 0.005 | 0.122 | 0.004 |
| 5 | Aluminium | 10.2 | 0.119 | 0.014 | 0.105 | 0.022 |
| 10 | Steel | 10.2 | 0.315 | 0.315 | 0.001 | 0.010 |
| 10 | Aluminium | 10.2 | 0.324 | 0.307 | 0.017 | 0.005 |
| 20 | Steel | 10.2 | 1.363 | 1.424 | 0.061 | 0.001 |
| 20 | Aluminium | 10.2 | 1.389 | 1.424 | 0.035 | 0.008 |
| 10 | Steel | 15.2 | 0.060 | 0.068 | 0.008 | 0.012 |
| 10 | Aluminium | 15.2 | 0.060 | 0.070 | 0.011 | 0.003 |
| 20 | Steel | 15.2 | 0.298 | 0.381 | 0.083 | 0.005 |
| 20 | Aluminium | 15.2 | 0.307 | 0.402 | 0.095 | 0.004 |

### B. Comparison of Models

The following results are obtained after calibrating the system using the offset-correction method.

Table III confirms that models that are based on time domain datasets have similar performances. The model based on v_{c2} has better average performance than v_{ds} in the inner fit region, while its average performance around outliers is slightly worse.

TABLE III
MODEL ERRORS (N WITHIN INNER FIT
REGION, O CLOSE TO OUTLIERS)

| Model | \|E̅r̅r̅\| N | \|E̅r̅r̅\| O | Max(\|E̅r̅r̅\|)N | Max(\|E̅r̅r̅\|) O |
|---|---|---|---|---|
| Scope v_{c2} | 0.87 | 1.30 | 2.90 | 4.10 |
| Scope v_{ds} | 0.80 | 1.63 | 3.00 | 5.60 |
| Scope v_{ds} 6 points | 0.92 | 1.38 | 4.09 | 4.60 |
| Scope | 1.00 | 2.80 | 6.00 | 8.30 |
| H_{1, 2} − PH₁₂ v_{c2} | | | | |
| Scope | 0.81 | 1.10 | 3.00 | 2.94 |
| H_{1, 2} − PH₁₂ v_{ds} | | | | |
| Subsampling v_{c2} | 0.69 | 1.84 | 5.40 | 7.70 |
| Extracted | 0.81 | 1.47 | 3.60 | 4.30 |
| H_{1, 2} − PH₁₂ v_{c2} | | | | |
| Extracted | 0.54 | 0.77 | 1.80 | 2.50 |
| i_{dcA} − H₁v_{c2} | | | | |

Interestingly, the model obtained through sub-sampling of v_{c2} has a higher average performance than the one obtained from direct scope measurements in the inner fit region, while performing worse around outliers and in terms of maximum error. Averaging of multiple individual samples with the sub-sampling method leads to a more precise measurement of the waveform since high frequency noise is attenuated, however the equivalent time resolution obtained with this method, set by the delay line's minimum timestep, is lower than the one of the oscilloscopes (2 GHz for sub-sampling and 2.5 GHz for the oscilloscopes). Moreover, the time-step of the delay line used for this method is not perfectly linear, causing distortion to the reconstructed waveform along the x-axis. This leads to the different performance of the two models depending on the operating region.

The combination of the three DC features obtained from the harmonics (H₁, H₂, PH₁₂) closely matches the performance of the time domain models, but considering that overall the number of features is much smaller, this method is much more practical in terms of implementation. The best model is obtained from the dcA-H₁ pair. Its error is close to half the error of all the other models, even around outliers. While other combinations of dcA with H₁, H₂ and PH₁₂ were tested, dcA-H₁ slightly outperformed the other models.

The average response times of the models range from 120 ms (for models relying on 2 input variables) to 150 ms (for models relying on more than 200 input variables).

The results in the following sections are obtained using the model based on the dcA-H₁ pair, since it is both simpler than the other models, easier to integrate and achieves the best performance.

### Practical Applications of the Proposed v_{M} Measurement Techniques

The v_{M} predictions obtained through the proposed dcA-H₁ model can be used for multiple purposes.

### A. FOD

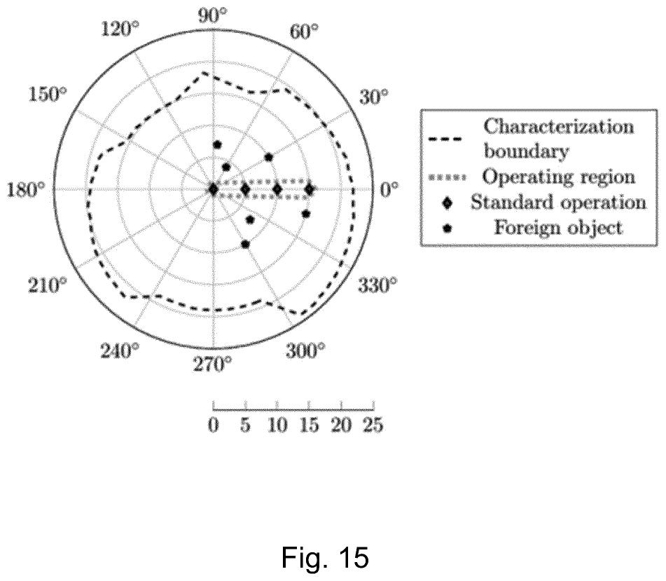

FOD is an interesting application of this concept, since deviations from the expected v_{M} are either caused by faults or foreign objects. As shown in FIG. 15 it is possible to set an inverter operating region within the characterisation boundary. This region is obtained as all the expected operating conditions for a set of given loads. The expected vis real and positive for a transceiver sending power. When a measured point falls outside of this region the inverter is not operating as expected: if the EMF_{Re} is too large it means the inverter is probably overloaded, while if EMF_{Im} is higher or lower than the model's maximum error (2.5 V) it means a foreign object is detected. A foreign object that reflects a positive EMF_{Im} indicates that the element coupled to the coil has an equivalent capacitive impedance, while a foreign object that reflects a negative EMF Im has an inductive one.

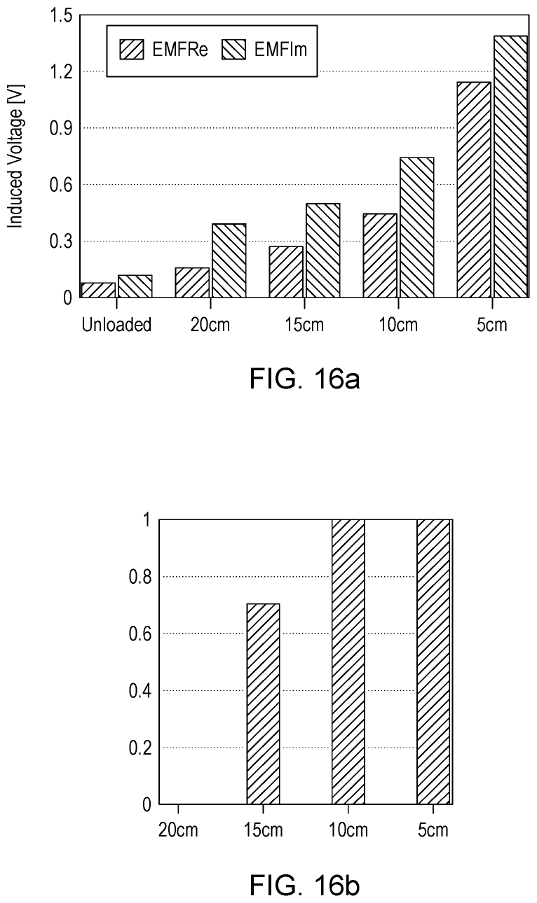

FIG. 16 depicts model predictions for detection of a salt water container at different distances. FIG. 16a is an induced voltage prediction (10 samples average). The y axis is the induced voltage measured in volts. FIG. 16b is detection accuracy with a single measurement (10 samples average).

In the experimental data reported in FIG. 16 it is shown how the FOD setup performs for a plastic container filled with 1 kg of saline solution at a 0.4% concentration to emulate the electromagnetic profile of muscle. This aims to replicate the presence of human body tissues in proximity of the coil.

It is possible to notice that a variation in induced voltage is detected even at a distance of 20 cm, however the standard deviation of the model prediction does not make it possible to capture this variation reliably within one measurement, leading to a less sensitive model. Subsequent measurements can be taken to improve the model's accuracy, increasing the instrument sensitivity at the cost of slower response times: taking the average of three measurement would lead to a 99.9% detection accuracy even for a distance of 15 cm, but the response time would increase from 120 ms to 360 ms.

### B. Synchronization of Active Rectifiers and Bidirectional Systems

Knowing the angle of v_{M} allows for correction of the phase between transceivers. Assuming a matched switching frequency of the two transceivers, phase correction for operation at unity power factor can be performed in a single step.

While it is possible to perform subsequent corrections to improve accuracy and decrease the imaginary component of v_{M}, the model's standard deviation and offset on EMF_{Im} predictions will dictate the minimum achievable angle error.

This approach can be advantageous in synchronisation techniques that require a search algorithm for optimal phase identification. Most of these techniques rely on sweeping the phase value and estimate the optimal relative phase between transceivers. For high coupling conditions this phase sweep could be unfeasible due to the detuning of either of the two transceivers, leading to potential heating and circuitry damage. Using the method proposed in this work would instead make it possible to achieve a fast convergence time without detuning the system.

In an example of synchronisation of an active rectifier at a coupling of 1.6%, the magnitude of the angle error may not exceed 10°.

The induced voltage in IPT systems provides valuable information about the interaction between the system's primary side and the environment, including tuned receivers and foreign objects. Unfortunately this induced voltage is not directly measurable when the system is in operation.

In this work two techniques have been presented for the estimation of the induced voltage in the coil of a Class EF-based transceiver, which use cost-effective components allow-ing the techniques to be deployed in real systems. The first, based in the time domain, reconstructs the switching waveform through sub-sampling rather than using a high-performance oscilloscope. The second technique, based in the frequency domain, analyses the information content in the amplitude and phase of the first two harmonics of the waveform. A combination of i_{dc} and H₁ were able to produce the most accurate estimate of v_{M}. This model is also the fastest and the one with the highest data-density. The individual candidate variables were assessed following a statistical approach to quantify correlation with the real and imaginary parts of the induced voltage.

It has been shown that, in a bidirectional system, v_{M} can be estimated with a maximum error of 2.5 V (6%) and an average error of 0.62 V (1.6%) using exclusively two measurable variables extracted as DC voltages. The measurement process can be fast (120 ms), making it suitable for applications where a quick response time is required.

Reflected impedance estimations can be performed with a maximum error of 0.122Ω. Phase synchronisation of active transceivers can be achieved quickly and accurately with angle errors lower than 10° in a single adjustment step. Foreign object detection can be reliably performed at a distance of one coil diameter with both metallic objects and salt water.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method of determining a magnetically induced voltage on a coil of a wireless power transmission device, the method comprising:
supplying DC input power to the wireless power transmission device;
monitoring a first variable associated with the wireless power transmission device;
monitoring a second variable associated with the wireless power transmission device, wherein at least one of the first and the second variable is derived from a switching waveform;
determining, based on at least one of the first variable, the second variable, and the relationship between the first variable and the second variable, the magnetically induced voltage on the coil of the wireless power transmission device.

2. The method of claim 1, further comprising:
determining, based on the magnetically induced voltage, whether a foreign object is present within wireless power transmission range of the wireless power transmission device.

3. The method of claim 2, further comprising:
in response to determining that a foreign object is present within wireless power transmission range of the wireless power transmission device, reducing or interrupting a power supply to the wireless power transmission device.

4. The method of claim 1, wherein monitoring a first variable associated with the wireless power transmission device further comprises:
extracting at least one harmonic from the switching waveform;
wherein the first variable is associated with the at least one extracted harmonic.

5. The method of claim 1, wherein the first variable is at least one of:
an amplitude of a first (fundamental) harmonic of the switching waveform;
an amplitude of a second harmonic of the switching waveform;
an amplitude of a third harmonic of the switching waveform.

6. The method of claim 1, wherein monitoring a second variable associated with the wireless power transmission device further comprises:
extracting at least one harmonic from the switching waveform;
wherein the second variable is associated with the at least one extracted harmonic.

7. The method of claim 1, wherein the second variable is at least one of:
a phase difference between the first (fundamental) harmonic of the switching waveform and the second harmonic of the switching waveform;
an input current.

8. The method of claim 4, wherein the at least one harmonic is extracted using a bandpass filter.

9. The method of claim 1, wherein there is an inverter associated with the wireless power transmission device.

10. The method of claim 9, wherein the inverter is one of:
a class EF inverter;
a class E inverter;
a class phi-2 inverter.

11. The method of claim 9, wherein the inverter is one of:
a single ended inverter;
a push-pull inverter.

12. The method of claim 9, wherein the switching waveform is a drain voltage waveform, or a filtered version of the drain voltage waveform.

13. The method of claim 12, wherein the inverter is a class EF inverter and switching waveform is an EF branch capacitor voltage waveform.

14. The method of claim 1, wherein the first variable is indicative of an imaginary component of the magnetically induced voltage, and wherein the second variable is indicative of a real component of the magnetically induced voltage.

15. The method of claim 14, wherein the first variable is indicative of a reactive power transferred between a transmitter and a receiver of the wireless power transmission device and the second variable is indicative of a real power wirelessly transmitted by the wireless power transmission device.

16. The method of claim 1, wherein monitoring at least one of the first and the second variable derived from the switching waveform comprises sub-sampling the switching waveform, and wherein subsampling consists of performing measurements at a frequency that is an integer multiple of a switching frequency of the switching waveform.

17. A wireless power transmission system, comprising:
a wireless power transmission device for wirelessly transmitting power to an electronic receiver device; and
at least one processor configured to perform the method of claim 1.
